(19) United States
(12) Patent Application Publication
(10) Pub. No.: US 2022/0106666 A1
(43) Pub. Date: Apr. 7, 2022

(54) RECYCLING METHOD FOR ALUMINUM ALLOY

(71) Applicants: KABUSHIKI KAISHA TOYOTA CHUO KENKYUSHO, Nagakute-shi, Aichi-ken (JP); TOYOTA JIDOSHA KABUSHIKI KAISHA, Toyota-shi, Aichi-ken (JP); TOYOTA TSUSHO CORPORATION, Nagoya-shi, Aichi (JP)

(72) Inventors: Takuma MINOURA, Nagakute-shi (JP); Jun YAOKAWA, Nagakute-shi (JP); Yasushi IWATA, Nagakute-shi (JP); Hiroshi KAWAHARA, Nagakute-shi (JP); Kazuma HIBI, Nagakute-shi (JP); Noriyuki UENO, Toyota-shi (JP); Akira KANO, Toyota-shi (JP); Yusei KUSAKA, Toyota-shi (JP); Kyosuke ITO, Nagoya-shi (JP); Tomoo MURATA, Tahara-city (JP)

(73) Assignees: KABUSHIKI KAISHA TOYOTA CHUO KENKYUSHO, Nagakute-shi, Aichi-ken (JP); TOYOTA JIDOSHA KABUSHIKI KAISHA, Toyota-shi, Aichi-ken (JP); TOYOTA TSUSHO CORPORATION, Nagoya-shi, Aichi (JP)

(21) Appl. No.: 17/421,897

(22) PCT Filed: Nov. 25, 2019
(86) PCT No.: PCT/JP2019/045903

§ 371 Date: Jul. 9, 2021

(30) Foreign Application Priority Data
Jan. 16, 2019 (JP) 2019-005022

(51) Int. Cl. C22B 21/06; C22C 21/14

(52) U.S. Cl. CPC C22B 21/06; C22C 21/14

(57) ABSTRACT

A recycling method for aluminum alloy is capable of offering a recycled Al alloy (melt), in which the Fe concentration is efficiently reduced, while using Al alloy scrap and the like as raw materials. The method includes: a preparation step of preparing a first melt by melting an Fe.Mn-containing material that contains Fe and Mn and an Al alloy raw material; a crystallization step of holding the first melt at a separation temperature at which an Fe compound crystallizes; and an extraction step of extracting a second melt obtained by removing at least part of the Fe compound crystallized from the first melt. The Fe.Mn-containing material preferably has a mass ratio of Mn to Fe (Mn/Fe) of, for example, 2 or more.

### TECHNICAL FIELD

The present invention relates to a method of obtaining a recycled Al alloy from scrap and the like.

### BACKGROUND ART

With the recent rise in environmental awareness, various components and devices are being reduced in weight, and the used amount of aluminum alloy (simply referred to as “Al alloy”) is increasing. A large amount of energy is required for the production (smelting) of new Al. In contrast, the energy required for remelting scrap of Al alloy is very little. It is thus desired to recycle scrap of Al alloy and use the recycled Al alloy.

When Al alloy scrap is remelted, Fe is usually mixed in the melt. To obtain the recycled Al alloy from scrap, removal of unnecessary elements (impurity elements) is required. Relevant descriptions of methods for removing such elements are found in the following documents.

### CITATION LIST

### Patent Literature

PTL 1: U.S. Pat. No. 2,464,610

PTL 2: U.S. Pat. No. 5,741,348

PTL 3: Japanese Unexamined Patent Application Publication No 2002-155322

PTL 4: U.S. Pat. No. 4,734,127

PTL 5: WO2013/168213

PTL 6: WO2013/168214

### Non Patent Literature

NPL 1: Furukawa Electric Review, No. 104 (July 1999) 25-30

NPL 2: Metallurgical Transactions 5 (1974) 785-787

NPL 3: Material Transactions, JIM.38 (1997) 622-699

### SUMMARY OF INVENTION

### Technical Problem

### (1) Intermetallic Compound Removal Method

PTL (Patent Literature) 1 and 2 and NPL (Non Patent Literature) relate to a method of removing Fe as an intermetallic compound from a melt. Specifically, PTL 1 discloses adding Cr, Mn, and Co to an Al-(11.6-13.5)% Si-(0.8-9)% Fe alloy to crystallize an Fe-based intermetallic compound to reduce the amount of Fe in the melt.

PTL 2 discloses adding Mn to an Al-(0-12)% Si-(0.49-2.1)% Fe-(0.37-1.91)% Mn alloy (Cr<0.4%, Ti<0.41%, Zr<0.26%, Mo<0.01%) to reduce the amount of Fe. However, its removal efficiency is low.

### (2) Segregation Solidification Method and Crystal Fractionation Method

PTL 3 to 6 and NPL 1 and 2 relate to a segregation solidification method or a crystal fractionation method that includes crystallizing an Al phase from a melt to obtain a semi-solidified melt and separating the Al crystallized substance from the residual liquid phase to reduce impurities. NPL 1 discloses pressurizing the semi-solidified melt to remove the residual liquid phase. NPL 2 discloses stirring the semi-solidified melt to spheroidize the Al crystallized substance and separating it from the residual liquid phase. Such methods require cooling the melt until the Al phase is crystallized, and the energy loss is thus large.

### (3) Semi-molten Refining Method

NPL 3 relates to a semi-molten refining method that includes heating an Al alloy (solid) to a semi-molten state to separate it into a liquid phase and residual Al crystals and removing impurities exceeding the solid solubility limit of the Al phase. Specifically, NPL 3 discloses pressurizing an Al-8.39% Si-0.06% Mn-0.05% Mg alloy in a semi-molten state to separate a liquid phase and obtaining an Al-0.96% Si-1.14% Mn-1.56% Mg alloy from the residue. In this method, it is difficult to remove Fe and Mn via an intermetallic compound. Moreover, the amount of residual Al crystals in the semi-molten state depends on the temperature and, therefore, alloy compositions for which this method can be used are limited.

### (4) Zone Melting Method

Other methods than the above-described methods for removing impurities from an Al alloy include a zone melting method that includes partially heating/melting an ingot from its one end side to collect impurities on the other end side and enhancing the purity on the one end side from which the heating was started.

The present invention has been made under such circumstances and an object of the present invention is to provide a recycling method capable of obtaining an Al alloy (melt) in which the Fe concentration is efficiently reduced by a different method than the conventional methods.

### Solution to Problem

As a result of intensive studies to achieve the above object, the present inventors have successfully reduce the concentration of Fe contained in an Al alloy melt obtained by melting scrap and the like, rather, through adding an Fe.Mn-containing material that contains Fe, which is an object to be removed (i.e., impurity), to the Al alloy melt. Developing this achievement, the present inventors have accomplished the present invention as will be described hereinafter.

### Recycling Method for Aluminum Alloy

(1) The present invention provides a recycling method for aluminum alloy, comprising: a preparation step of preparing a first melt by melting an Fe.Mn-containing material that contains Fe and Mn and an Al alloy raw material; a crystallization step of crystallizing an Fe compound from the first melt; and an extraction step of obtaining a second melt obtained by removing at least part of the Fe compound crystallized from the first melt.

(2) According to the recycling method for aluminum alloy (simply referred to as a “recycling method”) of the present invention, it is possible to promote crystallization of a compound, an alloy, or the like that contains Fe as an impurity (simply referred to as an “Fe compound”) from the first melt obtained by melting the Al alloy raw material. This allows to reduce the Fe concentration of the first melt in a short time, and a recycled Al alloy with sufficiently low Fe content can be efficiently obtained.

The recycled Al alloy obtained by the recycling method of the present invention may be in a solid phase state or may also be in a liquid phase state (i.e., a melt state). The recycled Al alloy in the liquid phase state can be reused as a recycled bare metal without any processing such as remelting.

(3) In contrast to conventional methods, the present invention allows to reduce the Fe concentration rapidly by adding the Fe.Mn-containing material, which contains Fe as an object to be removed, to the Al alloy raw material (melt) composed of scrap and the like. The reason that the Fe concentration can be efficiently reduced is not necessarily sure, but is envisaged as follows.

First, the Fe.Mn-containing material used in the present invention is composed of an alloy, a compound, or the like, and its melting point is usually sufficiently lower than the melting point of pure Fe or pure Mn. The Fe.Mn-containing material can therefore readily dissolve during the preparation step. In the case of the present invention, however, it is unnecessary to dissolve the added Fe.Mn-containing material completely during the preparation step.

Next, the addition of the Fe.Mn-containing material causes temporary increase of the Fe concentration in the first melt. This rather promotes the generation and growth of the Fe compound. This tendency becomes remarkable as the temperature of the first melt lowers. The Fe compound thus crystallized settles out at the bottom part of a crucible or the like due to the specific gravity difference from that of the Al liquid phase. As a result, a melt of the recycled Al alloy having a sufficiently reduced Fe concentration can be obtained in the upper layer part of the melt. This melt can be extracted to obtain the second melt.

In any case, the recycling method of the present invention is innovative in the point that the material which contains the impurity (Fe) as an object to be removed is rather added to the raw material melt for rapid reduction of the Fe concentration.

### Others

(1) The Fe compound as referred to in the present description is not limited in its specific composition, form, and the like, if the Fe compound can be separated from the first melt (extraction of the second melt is possible). The Fe compound may be, for example, an intermetallic compound that contains Fe, an alloy that contains Fe, or a mixture thereof. Typical Fe compounds include, for example, Al₁₃Fe₄, Al₁₅Si₂(Fe, Mn)₄, and the like.

(2) Unless otherwise stated, the concentration and composition as referred to in the present description are indicated by a mass ratio (mass %) with respect to the whole of an object (such as a melt, an alloy, or a compound) that falls within a range of interest. In the present description, mass % is simply indicated by “%” as appropriate.

(3) Unless otherwise stated, a numerical range “x to y” as referred to in the present description includes the lower limit x and the upper limit y. Any numerical value included in various numerical values or numerical ranges described in the present description may be selected or extracted as a new lower or upper limit, and any numerical range such as “a to b” can thereby be newly provided using such a new lower or upper limit.

### BRIEF DESCRIPTION OF DRAWINGS

FIG. 1 is a scatter diagram illustrating the influence of the Mn/Fe (mass ratio) of the Fe.Mn-containing material on the Fe concentration in a liquid phase portion in a melt (treated melt) after the treatment of adding the Fe.Mn-containing material.

FIG. 2 is a graphical table listing and illustrating the influence of the Cu concentration and Si concentration in the first melt on the Fe concentration in the liquid phase portion in the treated melt.

FIG. 3 is a scatter diagram illustrating the influence of the Mg concentration in the first melt on the Fe concentration in the liquid phase portion in the treated melt.

FIG. 4 is a set of SEM images showing the metallographic structure of an Al alloy according to each sample.

FIG. 5 is a graph illustrating the relationship between the cooling time from 730° C. to 575° C. and the Fe concentration in the liquid phase portion of the treated melt (Fe concentrations at 0 min represent the initial concentrations at 730° C.).

### DESCRIPTION OF EMBODIMENTS

One or more features freely selected from the present description can be added to the above-described features of the present invention. In the content as described in the present description, methodological features can even be features regarding a product (e.g., a recycled Al alloy (melt)).

### Influencing Factors on Fe Concentration

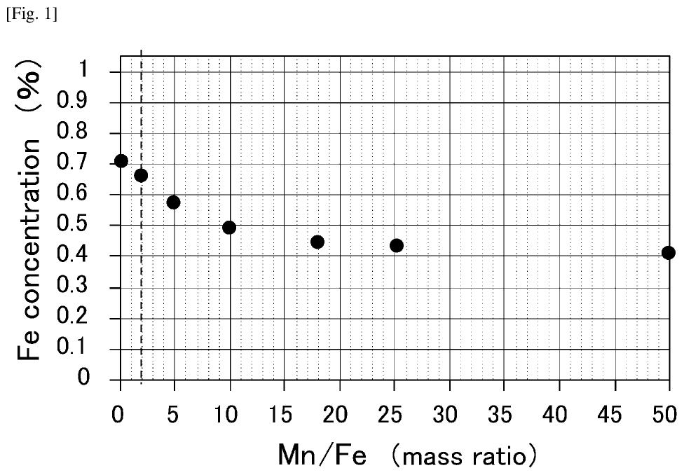

In relation to the recycling method of the present invention, factors influencing on the Fe concentration in a melt after the treatment of adding the Fe.Mn-containing material were studied. The results are illustrated in FIG. 1 to FIG. 3. FIG. 1 to FIG. 3 were obtained from calculations based on the Scheil equation using analysis software (“Thermo-Calc” available from Thermo-Calc Software AB).

### (1) Mn/Fe (Mass Ratio)

FIG. 1 illustrates the relationship between the mass ratio (Mn/Fe) of Fe and Mn contained in the Fe.Mn-containing material and the Fe concentration in a liquid phase portion in a melt after the treatment of adding the Fe.Mn-containing material (melt after crystallizing the Fe compound from the first melt/this melt is referred to as a “treated melt”).

The first melt was obtained by melting weighed Al alloy raw material (Al-12% Si-3% Cu-1% Fe-0.3% Mn) and the Fe.Mn-containing material at a compounding ratio of 30:1 (=Al alloy raw material:Fe.Mn-containing material). In the case of this compounding ratio, the melting point of the first melt is the melting temperature (700° C.) of a commonly used Al alloy.

As apparent from FIG. 1, it can be found that when the Mn/Fe of the Fe.Mn-containing material is 2 or more in an aspect, 5 or more in another aspect, or 8 or more in still another aspect, the Fe concentration in the treated melt decreases. When the Mn/Fe is 10 or more, the decrease in the Fe concentration is moderate. Accordingly, the Mn/Fe may be 30 or less in an embodiment, 25 or less in another embodiment, 15 or less in still another embodiment, or 12 or less in yet another embodiment.

### (2) Si Concentration and Cu Concentration

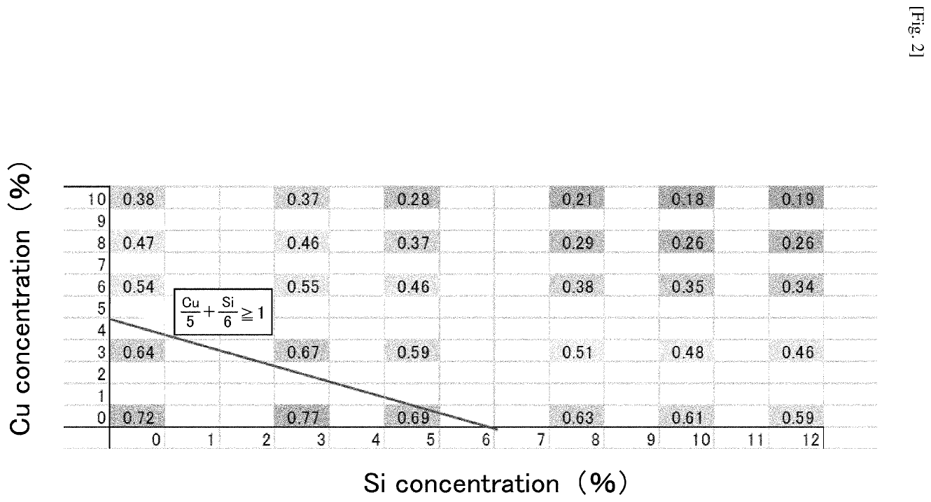

FIG. 2 is a graphical table listing and illustrating the relationship between the Si concentration (x) and Cu concentration (y) in the first melt and the Fe concentration (numerical value in each cell) in the liquid phase portion in the treated melt. Here, the first melt was obtained by compounding and melting an Al alloy raw material (Al-x′% Si-y′% Cu-1% Fe-0.3% Mn) and the Fe.Mn-containing material (Mn/Fe=23) at a compounding ratio of 30:1 as in the above-described case. The alloy composition of this first melt is approximately Al-x% Si-y% Cu-1.06% Fe-2.55% Mn according to calculations.

As apparent from FIG. 2, it can be found that the Fe concentration decreases to 0.68% or less in an aspect or 0.6% or less in another aspect within a range of (Cu/5)+(Si/6)≥(i.e., 6Cu+5Si≥30) in an aspect or (Cu/7)+(Si/8)≥1 (i.e., 8Cu+7Si≥56) in another aspect, in terms of mass %. Accordingly, the first melt may contain Cu and/or Si and may satisfy 6Cu+5Si≥1 (unit: mass %) when the first melt as a whole is 100 mass %.

Cu and Si are elements effective in improving the characteristics (such as strength) of an Al alloy. The first melt may contain, for example, Cu: 1% to 10% in an embodiment or 2% to 6% in another embodiment and Si: 1% to 12% in an embodiment or 3% to 8% in another embodiment, provided that Cu and Si fall within the range defined by the above-described mathematical expression.

### (3) Mg Concentration

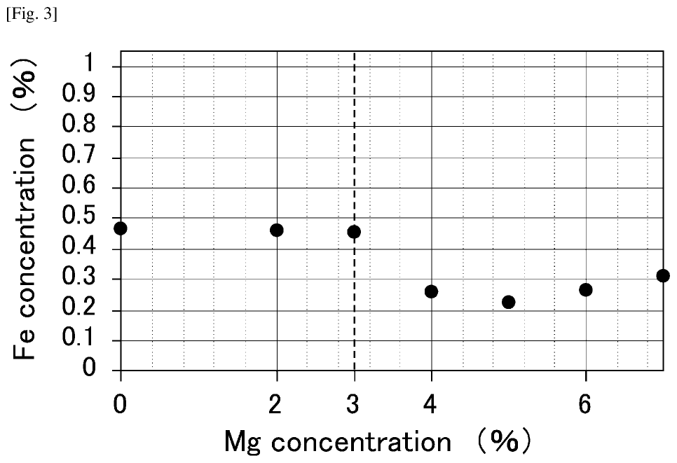

FIG. 3 illustrates the relationship between the Mg concentration in the first melt and the Fe concentration (reduction limit concentration) in the treated melt. Here, the first melt was obtained by melting weighed Al alloy raw material (Al-12% Si-3% Cu-1% Fe-0.3% Mn-z′% Mg) and the Fe.Mn-containing material (Mn/Fe=23) at a compounding ratio of 30:1 as in the above-described cases. The alloy composition of this first melt is approximately Al-12.4% Si-2.9% Cu-1.06% Fe-2.55% Mn-z% Mg according to calculations.

As apparent from FIG. 3, it can be found that when the Mg concentration in the first melt is 3% or more in an aspect, 4% or more in another aspect, or 5% or more in still another aspect, the Fe concentration in the treated melt decreases. When the Mg concentration is 4% or more, the decrease in the Fe concentration is moderate. Accordingly, the Mg concentration may be 7% or less in an embodiment, 6% or less in another embodiment, or 5% or less in still another embodiment.

Mg is also an element effective in improving the characteristics (such as strength) of an Al alloy. For example, when the Mg concentration is 3% or more, the Fe concentration (Fe solid solubility limit) in the treated melt is 0.46% or less, and a recycled Al alloy having high characteristics can be obtained accordingly. The first melt may therefore contain 3 mass % or more of Mg when the first melt as a whole is 100 mass %.

### Fe.Mn-Containing Material

The Fe.Mn-containing material can take various compositions and forms, provided that it contains Fe and Mn. The Fe.Mn-containing material may be composed of any of compounds (including intermetallic compounds), alloys, and mixtures thereof. In any case, the Fe.Mn-containing material usually has a lower melting point and better melting performance than those of Fe alone or Mn alone and is available at low cost. Such an Fe.Mn-containing material is preferred as a raw material for a recycled Al alloy.

As described above, the mass ratio (Mn/Fe) of Fe and Mn contained in the Fe.Mn-containing material may be 2 to 30 in an embodiment, 5 to 25 in another embodiment, or 8 to 12 or less in still another embodiment. Mn not only exhibits the effect of reducing the Fe concentration by itself, but also cooperates with Fe to reduce the Fe concentration. This appears to be because a compound that contains Fe and Mn, for example, Al₁₅(Fe, Mn)₄Si₂ is crystallized and coarsened readily. It also appears that the Fe.Mn-containing material itself serves as a nucleation site of the Fe compound and promotes the crystallization of the compound.

The Fe.Mn-containing material may further contain one or more of Si, Cu, Mg, Zn, Cr, Mo, V, Ti, or Al in addition to Fe and Mn. Si, Cu, Mg, and other similar elements are alloy elements, and Al is the primary element.

### Preparation Step

Preparation of the first melt is performed by melting the Al alloy raw material and the Fe.Mn-containing material at the same time or by adding the Fe.Mn-containing material into preliminary melted Al alloy row material. In any case, the Fe.Mn-containing material may not necessarily be completely dissolved.

The preferred heating temperature is a temperature high enough for melting at least the Al alloy raw material (Al phase portion). For example, the heating temperature ranges preferably from 650° C. to 930° C. or more preferably from 680° C. to 880° C. When Al alloy scrap is used as the Al alloy raw material, the preferred heating temperature is a temperature at which iron scrap and the like remain unmelted. The Al alloy scrap may be a wrought material or may also be a cast material.

### Crystallization Step

The melt temperature and the holding time may be adjusted such that the Fe compound crystallizes from the first melt. The melt temperature can be adjusted in accordance with the alloy composition of the first melt and may be set to, for example, (crystallization start temperature of α-Al)+(5° C. to 30° C. or preferably 10° C. to 20 ° C.), or 550° C. to 650° C., or preferably 565° C. to 630° C.

In the recycling method of the present invention, crystallization and growth of the Fe compound occur in an early stage. Accordingly, the time for holding such a melt temperature may be 3 to 60 minutes in an embodiment, 5 to 30 minutes in another embodiment, or 10 to 20 minutes in still another embodiment from starting to lower the temperature.

### Extraction Step

By removing at least part of the Fe compound crystallized from the first melt or of undissolved solids such as iron scrap, the second melt with low Fe concentration can be obtained. Extraction of the second melt can be performed, for example, by removing the Fe compound as a solid phase using a filter or the like from a crucible filled with the melt. Here, the Fe compound having a specific gravity larger than that of the melt tends to settle out to the melt lower layer. Extraction of the second melt may therefore be performed by taking out only the melt (supernatant melt having a reduced concentration of Fe) in the middle layer region to the upper layer region of the crucible. The extraction step may also include removing a residual solid undissolved in the preparation step (e.g., iron scrap and the like contained in part of the Al alloy raw material).

The extracted second melt may be used for production of wrought materials, cast materials, or the like without being solidified. The second melt may be further refined before use and/or adjusted to a desired component by adding pure Al (virgin ingot) and/or an alloy source (a component adjustment step). As will be understood, the second melt may be once solidified and then supplied as a recycled ingot.

### Examples

An Al alloy melt (treated melt) was prepared by adding the Fe.Mn-containing material. Metallographic structure observation and chemical composition analysis were performed using a sample obtained by solidifying the melt extracted from each layer region. The present invention will be described in more detail with reference to such specific examples.

### Production of Samples

### (1) Preparation Step

A raw material obtained by adding the Fe.Mn-containing material (30 to 50 g) to a die-cast material (JIS ADC12 equivalent/about 1.5 kg) as the Al alloy material was put in a graphite crucible (height 158 mm×upper diameter 120 mm×bottom diameter 80 mm, upper thickness 11 mm) and heated to 860° C. to melt. An Fe—Mn-based alloy with Mn/Fe=4 (mass ratio) was used as the Fe.Mn-containing material. Thus, an initial melt (first melt) of about 1.5 kg was prepared. The Fe.Mn-containing material melted completely in the initial melt.

After the initial melt was cooled in a furnace to 730° C., which is a commonly used heating temperature, and sufficiently stirred, part of the initial melt was poured into a mold for analysis (φ40 mm×30 mm) and placed to be cooled and naturally solidified in a room. Sample 1 is a specimen for analysis of initial melt composition.

### (2) Crystallization Step

The initial melt of 730° C. was cooled in a furnace to 575° C. (crystallization start temperature of α-Al plus 5° C.) for about 5 minutes. From the cooled melt (treated melt), the melt in each region of the upper layer part and lower layer part was extracted and solidified as follows.

For the upper layer part of the melt, only the supernatant melt was gently poured into the mold for analysis (φ40 mm×30 mm) remaining the solids (e.g., sediment) in the crucible. This was placed to be cooled and naturally solidified in a room, and Sample 2 for analysis of the upper layer part was thus obtained.

For the lower layer part of the melt, the residual melt (including the solidified substance) remaining at the crucible bottom after pouring the above upper layer part was scooped with a spoon and put in a mold for analysis (φ40×30 mm). This was placed to be cooled and naturally solidified in a room, and Sample 3 for analysis of the lower layer part was thus obtained.

### (3) Comparative Samples

For comparing purpose, a melt was prepared from only the Al alloy without adding the Fe.Mn-containing material and Samples C11, C12 and C13 for analysis were obtained. Sample C11 is a sample for initial concentration analysis produced by cooling the melt melted at 860° C. to 730° C. in a furnace and then pouring and solidifying part of the melt without any additional treatment. Sample C12 is a sample obtained by cooling the initial melt in the furnace to about 575° C. for 10 minutes and similarly pouring and solidifying the upper layer part of the melt. Sample C13 is a sample obtained by cooling the melt in the furnace from 730° C. to 575° C. for 90 minutes and similarly pouring and solidifying the upper layer part of the melt.

### Analysis of Samples

Samples 1 to 3 were subjected to the structure observation using a scanning electron microscope (SEM) and the Fe concentration analysis using fluorescent X-ray analysis. Samples C11 to C13 were also subjected to the Fe concentration analysis. The observation/analysis of each sample was performed for the central part (φ30 mm) of the horizontal cross section at the position of a height of about 5 mm from the sample bottom surface.

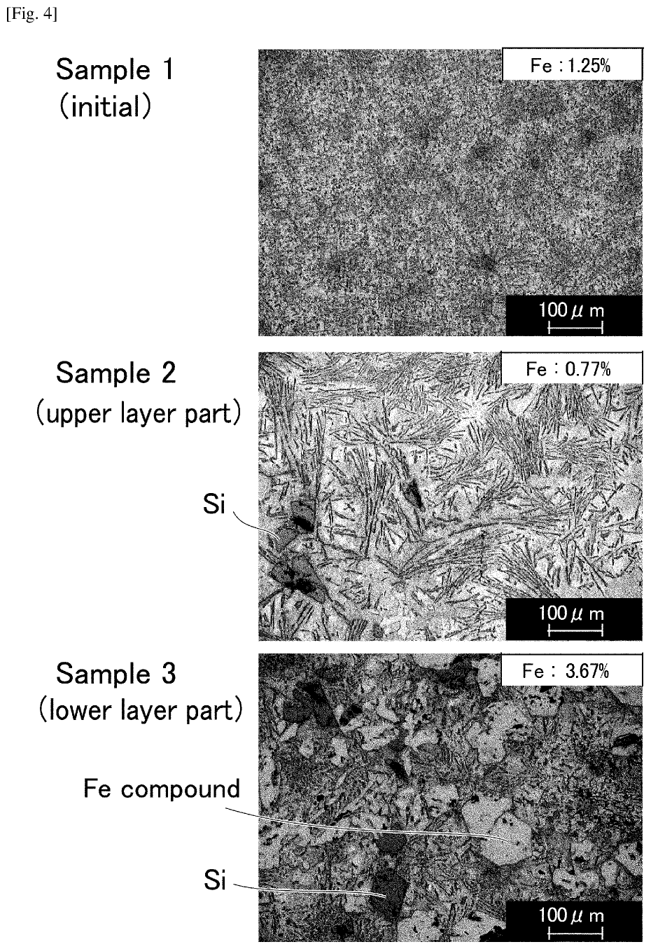

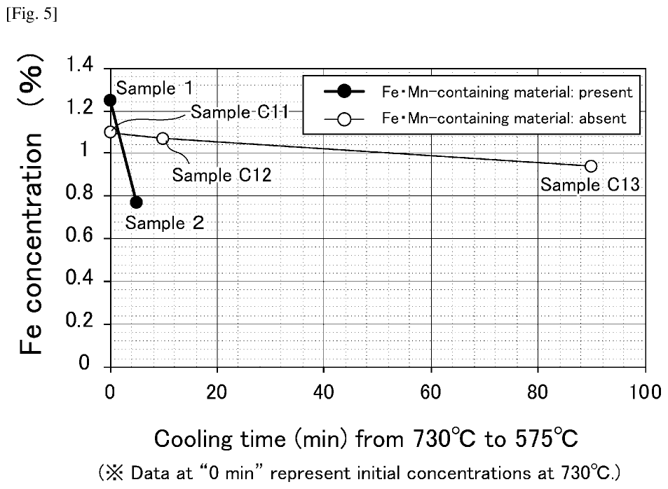

With regard to Samples 1 to 3, the observed structures and the analyzed Fe concentrations are shown together in FIG. 4. With regard to Samples 1 to 3 to which the Fe.Mn-containing material was added and Samples C11 to C13 to which the Fe.Mn-containing material was not added, the relationships between the elapsed time after melting (also referred to as a “holding time”) and the Fe concentration are illustrated in FIG. 5.

### Evaluation

(1) As apparent from FIG. 4, it has been confirmed that a melt (upper layer part) having a significantly reduced Fe concentration can be obtained by adding the Fe.Mn-containing material to the Al alloy raw material to prepare the melt. Specifically, as apparent from observation of the metallographic structure of Sample 2 (upper layer part), the crystallization of the Fe compound is small and the Fe concentration is reduced from 1.25% (Sample 1) to 0.77%. Moreover, as apparent from Sample 3, it has also been confirmed that the Fe content in the initial melt settles out as the Fe compound (solidified substance) at the bottom part of the crucible.

(2) As apparent from FIG. 5, it has been found that when the Fe.Mn-containing material is added, the Fe concentration in the melt (upper layer part) decreases rapidly from 1.25% to 0.77% (Fe concentration difference: 0.48%) only for about 5 minutes. On the other hand, when Fe.Mn-containing material is not added, even after 10 minutes, the Fe concentration in the upper layer part only decreases from 1.1% to about 1.05% (Fe concentration difference: about 0.05%). Furthermore, even after 90 minutes, the Fe concentration only decreases from 1.1% to about 0.95% (Fe concentration difference: about 0.15%).

From the above, it has been revealed that according to the recycling method of the present invention in which the Fe.Mn-containing material is added, a recycled Al alloy (melt) having a sufficiently reduced Fe concentration can be obtained in a short time from an Al alloy raw material such as scrap.

1. A recycling method for aluminum alloy, comprising:
a preparation step of preparing a first melt by melting an Fe.Mn-containing material and an Al alloy raw material, the Fe.Mn-containing material containing Fe and Mn;
a crystallization step of crystallizing an Fe compound from the first melt; and
an extraction step of extracting a second melt obtained by removing at least part of the Fe compound crystallized from the first melt.

2. The recycling method for aluminum alloy as recited in claim 1, wherein the Fe.Mn-containing material has a mass ratio of Mn to Fe (Mn/Fe) of 2 or more.

3. The recycling method for aluminum alloy as recited in claim 1, wherein the Fe.Mn-containing material further contains one or more of Si, Cu, Mg, Zn, Cr, Mo, V, Ti, or Al.

4. The recycling method for aluminum alloy as recited in claim 1, wherein
the first melt contains Cu and/or Si, and
6Cu+5Si≥1 (unit: mass %) is satisfied when the first melt as a whole is 100 mass %.

5. The recycling method for aluminum alloy as recited in claim 1, wherein the first melt contains 3 mass % or more of Mg when the first melt as a whole is 100 mass %.
